(19) United States
(12) Patent Application Publication
(10) Pub. No.: US 2016/0079811 A1
(43) Pub. Date: Mar. 17, 2016

(54) META-MATERIAL STRUCTURE

(71) Applicant: INTELLECTUAL DISCOVERY CO., LTD., Seoul (KR)

(72) Inventors: Chul Hun SEO, Seoul (KR); Hyoung Jun KIM, Seoul (KR); Sung Je LEE, Seoul (KR)

(73) Assignee: INTELLECTUAL DISCOVERY CO., LTD., Seoul (KR)

(21) Appl. No.: 14/888,010

(22) PCT Filed: Apr. 25, 2014
(86) PCT No.: PCT/KR2014/003627

§ 371 Date: Oct. 29, 2015

(30) Foreign Application Priority Data
Apr. 30, 2013 (KR) 10-2013-0048888

(51) Int. Cl. H02J 17/00

(52) U.S. Cl. CPC H02J 17/00

(57) ABSTRACT

The present invention relates to a meta-material structure and, more specifically, to a meta-material structure that refracts an electromagnetic field. According to one aspect of the present invention, a meta-material structure refracting a magnetic field of a particular frequency can be provided, wherein the meta-material structure comprises: a substrate; a first conductor line disposed on one surface of the substrate; a second conductor line disposed on the other surface of the substrate; and two connecting members for connecting both ends of the first conductor line and the second conductor line penetrating the substrate. When looked at from the top, both ends of the first conductor line and the second conductor line of the provided meta-material structure are located in the same place, and the first conductor line and the second conductor line form a twisted shaped path.

### BACKGROUND OF THE INVENTION

1. Field of the Invention

The present invention relates to a metamaterial structure, and more particularly, to a metamaterial structure that refracts an electromagnetic field.

2. Discussion of the Related Art

A wireless power transmission technology is a technology that wirelessly transmits power between a power source and an electronic apparatus. As one example, the wireless power transmission technology can wirelessly charge a battery of a mobile terminal just by putting a mobile terminal such as a smart phone or a tablet on a wireless charging pad to provide higher mobility, convenience, and safety than a wired charging environment using the existing wired charging connector. Further, the wireless power transmission technology attracts public attention to substitute the existing wired power transmission environment in various fields such as medical treatment, leisure, a robot, and the like, which include home appliances and an electric vehicle afterwards in addition to wireless charging of the mobile terminal.

The wireless power transmission technology may be classified into a technology using electromagnetic wave radiation and a technology using an electromagnetic induction phenomenon, and since the technology using the electromagnetic wave radiation has a limit of efficiency depending on radiation loss consumed in the air, the technology using the electromagnetic induction phenomenon has been primarily researched in recent years.

The wireless power transmission technology using the electromagnetic induction phenomenon is generally classified into an electromagnetic inductive coupling scheme and a resonant magnetic coupling scheme.

The electromagnetic inductive coupling scheme is a scheme that transmits energy by using current induced to a coil at a receiving side due to a magnetic field generated at a coil at a transmitting side according to electromagnetic coupling between the coil at the transmitting side and the coil at the receiving side. The wireless power transmission technology of the electromagnetic inductive coupling scheme has an advantage that transmission efficiency is high, but has a disadvantage that a power transmission distance is limited to several mms and is very sensitive to matching of the coils, and as a result, a degree of positional freedom is remarkably low.

The resonant magnetic coupling scheme as a technology proposed by Professor Marine Solarbeach of MIT in 2005 is a scheme that transmits energy by using a phenomenon in which the magnetic field focused on both sides of the transmitting side and the receiving side by the magnetic field applied at a resonance frequency between the coil at the transmitting side and the coil at the receiving side. As a result, the resonant magnetic coupling scheme is expected as the wireless power transmission technology that can transmit energy up to a comparatively long distance from several cms to several ms as compared with the magnetic inductive coupling scheme to implement authentic cord-free.

A metamaterial proposed by Professor Pendry in UK in 1999 as a material constituted by periodic arrays having a specific pattern generally means a material having a material property which cannot exist in nature. The metamaterial has a positive or negative refraction index with respect to the electromagnetic field as a primary characteristic and it is predicted that when the metamaterial is used, the electromagnetic field as a near field can be focused to improve coverage of wireless power transmission.

### SUMMARY OF THE INVENTION

An object of the present invention is to provide a metamaterial structure having a refraction index of ‘0’ or a negative refraction index with respect to an electromagnetic field having a specific frequency.

Effects of the present invention are not limited to the aforementioned effects and unmentioned effects will be clearly understood by those skilled in the art from the specification and the appended claims.

In accordance with an embodiment of the present invention, a metamaterial structure refracting a magnetic field having a specific frequency, includes: a substrate; a first conductor line deployed on one surface of the substrate; a second conductor line deployed on the other surface of the substrate; and two connection members connecting both ends of the first conductor line and the second conductor line through the substrate, wherein the first conductor line and the second conductor line have both ends positioned at the same location and are provided to form twisted paths.

Objects to be solved by the present invention are not limited to the aforementioned objects and unmentioned objects will be clearly understood by those skilled in the art from the specification and the appended claims.

According to the present invention, an electromagnetic field can be focused by using a metamaterial structure having a refraction index of ‘0’ or a negative refraction index with respect to a specific frequency and this is applied to a wireless power transmission technology to improve coverage of wireless power transmission.

Objects to be solved by the present invention are not limited to the aforementioned objects and unmentioned objects will be clearly understood by those skilled in the art from the specification and the appended claims.

### BRIEF DESCRIPTION OF THE DRAWINGS

FIG. 1 is a graph regarding an effective dielectric constant and effective permeability for each frequency of a magnetic field lens according to an embodiment of the present invention;

FIG. 2 is a block diagram of a wireless power transmitting system according to an embodiment of the present invention;

FIG. 3 is a block diagram of a wireless power transmitting apparatus according to the embodiment of the present invention;

FIG. 4 is a block diagram of a wireless power receiving apparatus according to the embodiment of the present invention;

FIG. 5 is a diagram illustrating magnetic field focusing of a metamaterial structure according to the embodiment of the present invention;

FIGS. 6 to 9 are diagrams regarding a metamaterial structure 1000 according to the embodiments of the present invention;

FIG. 6 is a plan view of a first form of the metamaterial structure according to the embodiment of the present invention;

FIG. 7 is a bottom view of the first form of the metamaterial structure according to the embodiment of the present invention;

FIG. 8 is a cross-sectional view of region A of FIG. 6;

FIG. 9 is a cross-sectional view of region B of FIG. 6;

FIG. 10 is a graph regarding a refraction index of the first form of the metamaterial structure according to the embodiment of the present invention;

FIG. 11 is a diagram regarding a second form of the metamaterial structure according to the embodiment of the present invention;

FIG. 12 is a diagram regarding a third form of the metamaterial structure according to the embodiment of the present invention;

FIG. 13 is a diagram regarding a fourth form of the metamaterial structure according to the embodiment of the present invention;

FIG. 14 is a diagram regarding a fifth form of the metamaterial structure according to the embodiment of the present invention;

FIG. 15 is a diagram regarding a sixth form of the metamaterial structure according to the embodiment of the present invention;

FIG. 16 is a diagram regarding a seventh form of the metamaterial structure according to the embodiment of the present invention; and

FIG. 17 is a diagram regarding an eighth form of the metamaterial structure according to the embodiment of the present invention.

### DETAILED DESCRIPTION OF THE EMBODIMENTS

Since embodiments disclosed in the specification are used to clearly describe the spirit of the present invention for those skilled in the art, the present invention is not limited to the exemplary embodiments disclosed in the specification and it should be analyzed that the scope of the present invention includes a modified example and a transformed example without departing from the spirit of the present invention.

Terms and the accompanying drawings used in the specification are used to easily describe the present invention and shapes illustrated in the drawings may be enlarged as necessary for help understanding the present invention, and as a result, the present invention is not limited by the terms and the drawings used in the specification. In describing the present invention, when it is determined that the detailed description of the known configuration or function related to the present invention may obscure the gist of the present invention, the detailed description thereof will be omitted.

In accordance with an embodiment of the present invention, a metamaterial structure refracting a magnetic field having a specific frequency, includes: a substrate; a first conductor line deployed on one surface of the substrate; a second conductor line deployed on the other surface of the substrate; and two connection members connecting both ends of the first conductor line and the second conductor line through the substrate, wherein the first conductor line and the second conductor line have both ends positioned at the same location and are provided to form twisted paths.

The first conductor line and the second conductor line may be provided to form having an ‘8’ shape, a twisted ribbon shape, or an unlimited symbol shape from the top view.

Further, the first conductor line and the second conductor line may be provided in such a manner that a path formed by the first conductor line and a path formed by the second conductor line cross each other.

The first conductor line and the second conductor line may be provided to form paths symmetric to each other based on a location where the path formed by the first conductor line and the path formed by the second conductor line cross each other from the top view.

At least one gap serving as an air capacitor may be formed on the paths formed by the first conductor line and the second conductor line.

The first conductor line and the second conductor line may be provided in such a manner that the path formed by the first conductor line and the path formed by the second conductor line cross each other from the top view, the first conductor line and the second conductor line may be provided to form paths symmetric to each other based on a location where the path formed by the first conductor line and the path formed by the second conductor line cross each other from the top view, and the at least one gap may be provided at the locations symmetric to each other based on the location where the first conductor line and the second conductor line cross each other or provided at the location where the first conductor line and the second conductor line cross each other.

The metamaterial structure may further include at least one capacitor inserted on the paths formed by the first conductor line and the second conductor line.

The first conductor line and the second conductor line may be provided in such a manner that the path formed by the first conductor line and the path formed by the second conductor line cross each other from the top view, the first conductor line and the second conductor line may be provided to form paths symmetric to each other based on a location where the path formed by the first conductor line and the path formed by the second conductor line cross each other from the top view, and the at least one capacitor may be provided at the locations symmetric to each other based on the location where the first conductor line and the second conductor line cross each other or provided at the location where the first conductor line and the second conductor line cross each other.

At least one of the first conductor line and the second conductor line may include a pattern line provided onto the formed by the first conductor line and the second conductor line in zigzags.

The first conductor line and the second conductor line may be provided in such a manner that the path formed by the first conductor line and the path formed by the second conductor line cross each other from the top view, the first conductor line and the second conductor line may be provided to form paths symmetric to each other based on a location where the path formed by the first conductor line and the path formed by the second conductor line cross each other from the top view, and the at least one patter line may be provided at the locations symmetric to each other based on the location where the first conductor line and the second conductor line cross each other or provided at the location where the first conductor line and the second conductor line cross each other.

Hereinafter, a metamaterial structure 1000 according to an embodiment of the present invention will be described.

A metamaterial means an artificial material designed to have a characteristic which cannot be found in general nature. A representative example among characteristics of the metamaterial may include a refraction index of ‘0’ or a negative refraction index with respect to an electromagnetic field.

The metamaterial may be prepared by primarily forming a specific pattern with a material such as metal or plastic and a characteristic material property of the metamaterial is given by not the material but the specific pattern. A representative example of the metamaterial may include a negative index material (NIM) having a negative value in both dielectric constant and permeability or single negative (SNG) having the negative value in only one of the dielectric constant and the permeability and may have such a property by patterning of a split ring resonator (SRR), and the like.

The metamaterial structure 1000 means a structure provided to have the characteristic of the metamaterial.

The metamaterial structure 1000 according to the embodiment of the present invention may focus the electromagnetic field.

The metamaterial structure 1000 may have the refraction index of ‘0’ (zero refraction index) or the negative refraction index (minus refraction index) as the refraction index for the electromagnetic field having the specific frequency. When a magnetic field passes through the metamaterial structure 1000 having the refraction index of ‘0’ or the negative refraction index, a similar effect to a case in which light passing through an optical lens is refracted is shown. That is, the metamaterial structure 1000 may focus the electromagnetic field which spreads radially in a desired direction.

When such an effect is used, the magnetic field which radially spreads from a wireless power transmitting apparatus 2100 may be refracted and focused in a vertical direction to the metamaterial structure 1000 or focused toward a wireless power receiving apparatus 2200 by using the metamaterial structure 1000.

Therefore, when the metamaterial structure 1000 is used, a rate at which the magnetic field radiated from the wireless power transmitting apparatus 2100 is radiated to an undesired atmosphere decreases, and as a result, radiation efficiency of the magnetic field transferred from the wireless power receiving apparatus 2200 from the wireless power transmitting apparatus 2100 increases, consequently, transmission efficient and a transmission distance may be improved while the wireless power transmission using the magnetic field.

A principle in which the metamaterial structure 1000 has the refraction index of ‘0’ or the negative refraction index with respect to the electromagnetic field will be described below.

A refraction index n for the electromagnetic field has the following functional relationship with respect to an effective dielectric constant eeff and effective permeability ueff.

n=eeff×ueff

Therefore, when the effective dielectric constant or effective permeability of the metamaterial structure 1000 is adjusted to ‘0’, the metamaterial structure 1000 has the refraction index ‘0’. Similarly, when any one of the effective dielectric constant and the effective permeability of the metamaterial structure 1000 is adjusted to have the negative value, the metamaterial structure 1000 may have negative permeability. Herein, the effective dielectric constant eeff and the effective permeability ueff may adjust the size, the shape, and an interval of a specific pattern, the number of pattern repetition times, inductance, capacitance, and the like constituting the metamaterial structure 1000. Therefore, the metamaterial structure 1000 having the refraction index of ‘0’ may be provided by adjusting the size, the shape, and the interval of the specific pattern, the number of pattern repetition times, the inductance, the capacitance, and the like constituting the metamaterial structure 1000 so that any one of the effective dielectric constant eeff and the effective permeability ueff becomes ‘0’.

Similarly, the metamaterial structure 1000 having the negative refraction index may be provided by adjusting the size, the shape, and the interval of the specific pattern, the number of pattern repetition times, the inductance, the capacitance, and the like constituting the metamaterial structure 1000 so that any one of the effective dielectric constant eeff and the effective permeability ueff becomes the negative value.

Meanwhile, since the effective dielectric constant eeff or the effective permeability ueff of the metamaterial structure 1000 varies differently for each frequency band, even though the effective dielectric constant eeff or the effective permeability ueff has the refraction index of ‘0’ or the negative refraction index with respect to a desired specific frequency, it should be noted that the effective dielectric constant eeff or the effective permeability ueff may not have the refraction index of ‘0’ or the negative refraction index with respect to other frequency bands.

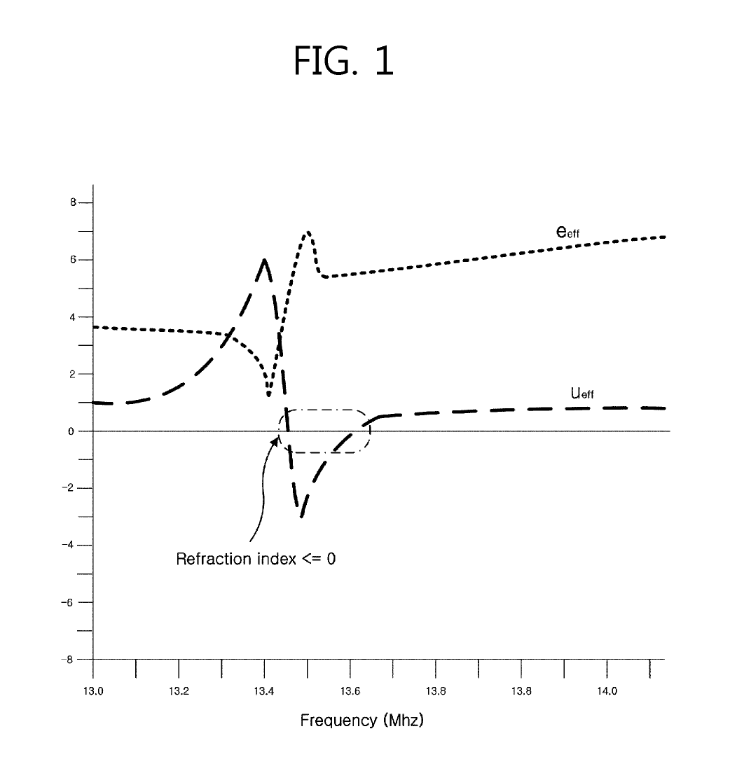

FIG. 1 is a graph regarding an effective dielectric constant and effective permeability for each frequency of a metamaterial structure 1000 according to an embodiment of the present invention.

Referring to FIG. 1 the metamaterial structure 1000 may have an effective permeability value of ‘0’ in approximately 13.6 Mhz. Therefore, the metamaterial structure 1000 has a refraction index of ‘0’ in the band of 13.6 MHz. Similarly, the metamaterial structure 1000 may have a negative effective permeability value in approximately 13.4 to 13.6 Mhz. Therefore, the metamaterial structure 1000 has a negative refraction index in the corresponding range.

When the metamaterial structure 1000 having the refraction index of ‘0’ or the negative refraction index is used in the wireless power transmitting system 2000, power transmission efficiency may increase by improving radiation efficiency while wireless power transmission.

Hereinafter, a wireless power transmitting system 2000 according to an embodiment of the present invention will be described.

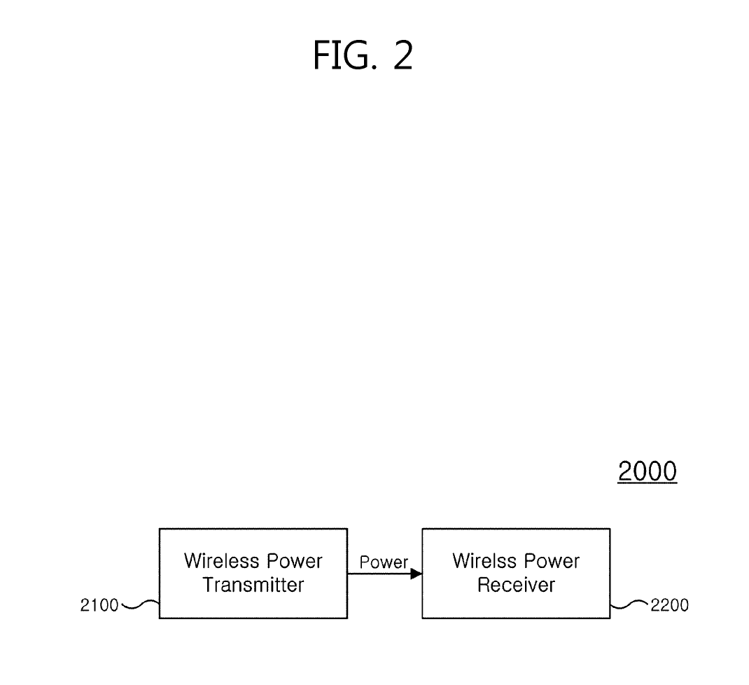

FIG. 2 is a block diagram of a wireless power transmitting system 2000 according to an embodiment of the present invention.

Referring to FIG. 2, the wireless power transmitting system 2000 includes a wireless power transmitting apparatus 2100 and a wireless power receiving apparatus 2200. The wireless power transmitting apparatus 2100 receives power from an external power source S to generate the magnetic field. The wireless power transmitting apparatus 2200 generates current by using the generated magnetic field to receive power wirelessly.

Herein, the wireless power transmitting apparatus 2100 may be provided as a fixed type or a movable type. An example of the fixed type includes a type which is embedded in a ceiling or a wall surface or a furniture such as a table, or the like indoor, a type which is installed in an outdoor parking lot, a bus stop, or a subway station as an implant type, or a type which is installed in transporting means such as a vehicle or a train. The movable wireless power transmitting apparatus 2100 may be implemented as a part of a movable apparatus having a movable weight or size or other apparatus such as a cover of a notebook computer, or the like.

Further, the wireless power transmitting apparatus 2200 should be analyzed as a comprehensive concept including various electronic apparatuses including a battery and various home appliances driven by receiving power wirelessly instead of a power cable. Representative examples of the wireless power transmitting apparatus 2200 include a portable terminal, a cellular phone, a smart phone, a personal digital assistant (PDA), a portable media player (PMP), a WiBro terminal, a tablet, a pablet, a notebook, a digital camera, a navigation terminal, a television, an electric vehicle (EV), and the like.

One or more wireless power transmitting apparatuses 2200 may be present in the wireless power transmitting system 2000. In FIG. 2, it is expressed that the wireless power transmitting apparatus 2100 and the wireless power receiving apparatus 2200 transmit and receive power one to one, but one wireless power transmitting apparatus 2100 may transmit power to the plurality of wireless power receiving apparatuses 2200. In particular, when the wireless power transmission is performed in the resonant magnetic coupling scheme, one wireless power transmitting apparatus 2100 may transmit power to a plurality of wireless power receiving apparatuses 2200 simultaneously by applying a simultaneous transmission scheme or a time division transmission scheme.

Meanwhile, although not illustrated in FIG. 2, the wireless power transmitting system 2000 may further include a relay for increasing a power transmission distance. As the relay, a passive type resonance loop implemented by an LC circuit may be used. The resonance loop may increase the wireless power transmission distance by focusing a magnetic field radiated to the atmosphere. It is possible to secure wider wireless power transmission coverage by simultaneously using a plurality of relays.

Hereinafter, the wireless power transmitting apparatus 2100 according to the embodiment of the present invention will be described.

The wireless power transmitting apparatus 2100 may transmit power wirelessly.

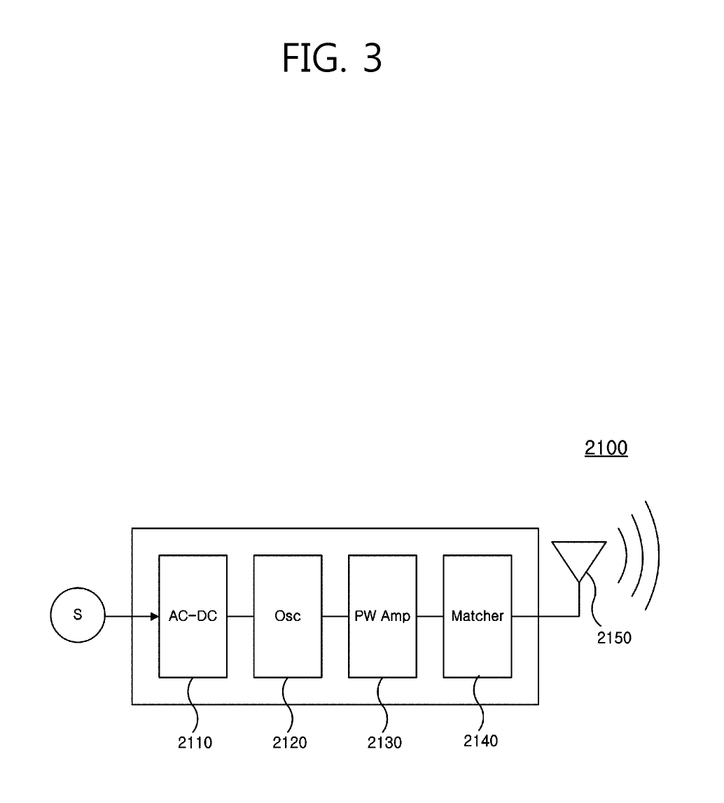

FIG. 3 is a block diagram of the wireless power receiving apparatus 2100 according to the embodiment of the present invention.

Referring to FIG. 3, the wireless power transmitting apparatus 2100 may include an AC-DC converter 2110, a frequency oscillator 2120, a power amplifier 2130, an impedance matcher 2140, and a transmitting antenna 2150.

The AC-DC converter 2110 may convert AC power into DC power. The AC-DC converter 2110 receives the AC power from the external power source S and converts a wavelength of the received AC power into the DC power and outputs the DC power. The AC-DC converter 2110 may adjust a voltage value of the output DC power.

The frequency oscillator 2120 may convert the DC power into AC power having a desired specific frequency. The frequency oscillator 2120 receives the DC power output by the AC-DC converter 2110 and converts the received DC power into AC power having a specific frequency and outputs the AC power. Herein, the specific frequency may be a resonance frequency. In this case, the frequency oscillator 2120 may output the AC power having the resonance frequency.

The power amplifier 2130 may amplify voltage or current of power. The power amplifier 2130 receives the AC power having the specific frequency, which is output by the frequency oscillator 2120, and amplifies voltage or current of the received AC power having the specific frequency and outputs the amplified voltage or current.

The impedance matcher 2140 may perform impedance matching. The impedance matcher 2140 may include a capacitor, an inductor, and a switching element that switches a connection thereof. Impedance matching may be performed by detecting a reflection wave of the wireless power transmitted through the receiving antenna 2150, adjusting a connection state of the capacitor or the inductor by switching the switching element based on the detected reflection wave, or adjusting capacitance of the capacitor or inductance of the inductor.

The transmitting antenna 2150 may general an electromagnetic field by using the AC power. The transmitting antenna 2150 receives the AC power having the specific frequency, which is output by the amplifier 2130 to thereby generate a magnetic field having a specific frequency. The generated magnetic field is radiated and the wireless power transmitting apparatus 2200 receives the radiated magnetic field to generate current. In other words, the transmitting antenna 2150 wirelessly transmits power.

Hereinafter, the wireless power transmitting apparatus 2200 according to the embodiment of the present invention will be described.

The wireless power transmitting apparatus 2200 may receive power wirelessly.

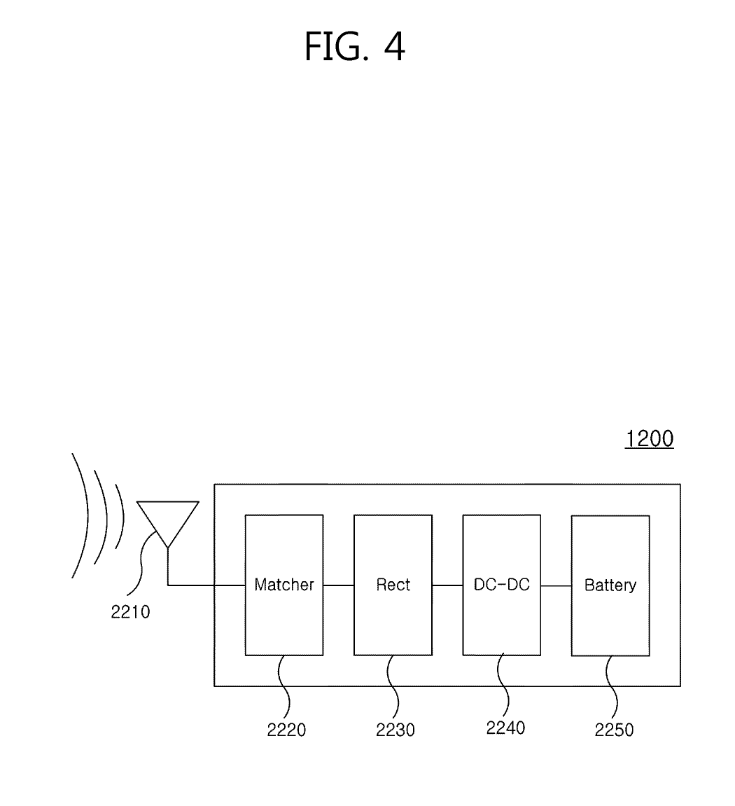

FIG. 4 is a block diagram of the wireless power receiving apparatus 2200 according to the embodiment of the present invention.

Referring to FIG. 4, the wireless power transmitting apparatus 2200 may include a receiving antenna 2210, an impedance matcher 2220, a rectifier 2230, a DC-DC converter 2240, and a battery 2250.

The receiving antenna 2210 may receive the wireless power transmitted by the wireless power transmitting apparatus 2100. The receiving antenna 2210 may receive power by using the magnetic field radiated by the transmitting antenna 2150. Herein, when a specific frequency is the resonance frequency, a magnetic resonance phenomenon occurs between the transmitting antenna 2150 and the receiving antenna 2210, and as a result, power may be more efficiently received.

The impedance matcher 2220 may adjust impedance of the wireless power transmitting apparatus 2200. The impedance matcher 2220 may include a capacitor, an inductor, and a switching element that switches a connection thereof. The impedance may be matched by controlling a switching element of a circuit constituting the impedance matcher 2220 based on a voltage value or a current value, a power value, a frequency value, and the like of the received wires power.

The rectifier 2230 rectifies the received wireless power to convert AC power to DC power. The rectifier 2230 may convert the AC power into the DC power by using a diode or a transistor and smooth the DC power by using the capacitor or a resistor. As the rectifier 2230, a full-wave rectifier, a half-wave rectifier, a voltage multiplier, and the like implemented by a bridge circuit, and the like may be used.

The DC-DC converter 2240 converts voltage of the rectified DC power into a desired level to output the voltage having the desired level. When a voltage value of the DC power rectified by the rectifier 2230 is larger or smaller than a voltage value required to charge the battery or drive the electronic apparatus, the DC-DC converter 2240 may change the voltage value of the rectified DC power to desired voltage.

The battery 2250 may store energy by using the power output from the DC-DC converter 2240. Meanwhile, the wireless power transmitting apparatus 2200 needs not particularly include the battery 2250. For example, the battery may be provided as an external component which is detachable. As another example, the wireless power transmitting apparatus 2200 may include driving means that drives various operations of the electronic apparatus instead of the battery 2250.

Hereinafter, a process in which the power is wirelessly transmitted in the wireless power transmitting system 2000 according an embodiment of the present invention will be described.

Wireless transmission of the power may be performed by using the electromagnetic inductive coupling scheme or the resonant magnetic coupling scheme. In this case, the wireless transmission of the power may be performed between the transmitting antenna 2150 of the wireless power transmitting apparatus 2100 and the receiving antenna 2210 of the wireless power receiving apparatus 2200.

When the resonant magnetic coupling scheme is used, each of the transmitting antenna 2150 and the receiving antenna 2210 may be provided in a form of a resonance antenna. The resonance antenna may have a resonance structure including the coil and the capacitor. In this case, the resonance frequency of the resonance antenna is determined by the inductance of the coil and the capacitance of the capacitor. Herein, the coil may be formed in a form of a loop. Further, a core may be placed in the loop. The core may include a physical core such as a ferrite core or an air core.

Energy transmission between the transmitting antenna 2150 and the receiving antenna 2210 may be performed through a resonance phenomenon of the magnetic field. The resonance phenomenon means a phenomenon in which both resonance antennas are coupled to each other, and as a result, energy is transferred between the resonance antennas with high efficiency in the case where other resonance antennas are positioned around one resonance antenna when a near field corresponding to the resonance frequency is generated in one resonance antenna. When the magnetic field corresponding to the resonance frequency is generated between the resonance antenna of the transmitting antenna 2150 and the resonance antenna of the receiving antenna 2210, the resonance phenomenon occurs, in which the resonance antennas of the transmitting antenna 2150 and the receiving antenna 2210, and as a result, in a general case, the magnetic field is focused toward the receiving antenna 2210 with higher efficiency than a case in which the magnetic field generated in the transmitting antenna 2150 is radiated to free space. Therefore, energy may be transferred from the transmitting antenna 2150 to the receiving antenna 2210 with high efficiency.

The electromagnetic inductive coupling scheme may be implemented similarly to the resonance magnetic coupling scheme, but in this case, the frequency of the magnetic field need not be the resonance frequency. Instead, in the electromagnetic inductive coupling scheme, matching the loops constituting the receiving antenna 2210 and the transmitting antenna 2150 is required and a gap between the loops needs to be very small.

Hereinafter, a process in which the power is wirelessly transmitted in the wireless power transmitting system 1000 according an embodiment of the present invention will be described.

When the power transmission is wirelessly performed by using the magnetic resonance as described above, the magnetic field which is a near field generated from the transmitting antenna 2150 spreads radially, and as a result, when a distance between the transmitting antenna 2150 and the receiving antenna 2210 increases, power transmission efficiency may deteriorate. The metamaterial structure 1000 may focus the magnetic field which spreads radially between the transmitting antenna 2150 and the receiving antenna 2210 to be radiated in a desired direction.

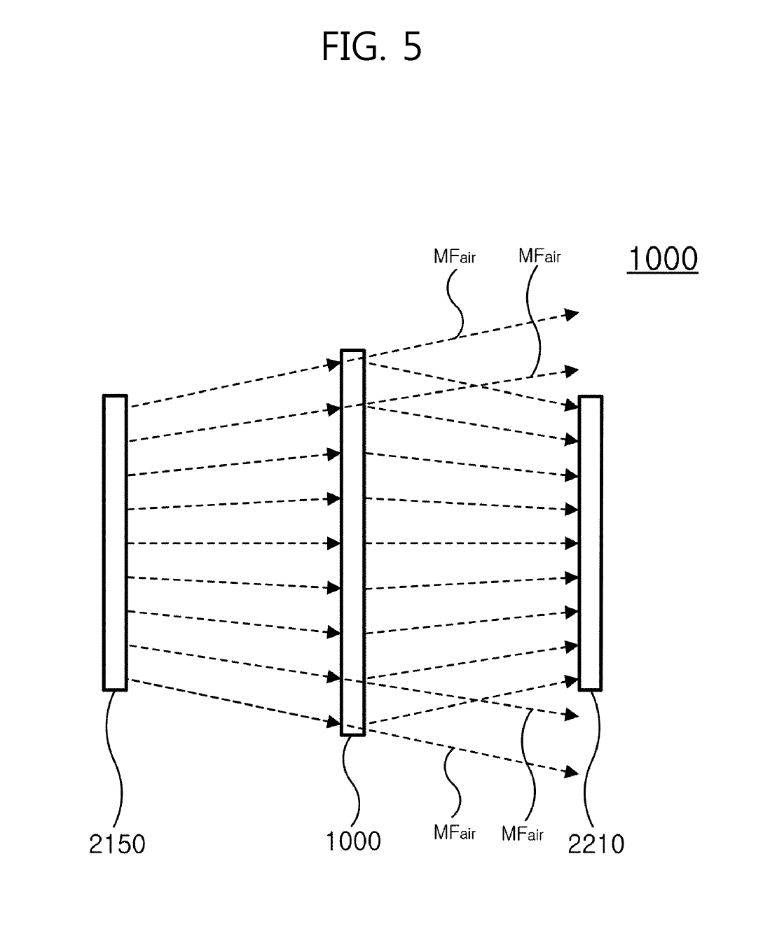

FIG. 5 is a diagram illustrating magnetic field focusing of a metamaterial structure 1000 according to the embodiment of the present invention.

Referring to FIG. 5, the wireless power transmitting apparatus 2100 radiates the magnetic field through the transmitting antenna 2150. The magnetic field spreads radially from the loop of the transmitting antenna 2150.

The metamaterial structure 1000 may be deployed between the transmitting antenna 2150 and the receiving antenna 2210. The metamaterial structure 1000 has the refraction index of ‘0’ or the negative refraction index with respect to the frequency of the radiated magnetic field.

For example, the metamaterial structure 1000 having the characteristic of FIG. 1 has the effective permeability of ‘0’ with respect to the magnetic field having the frequency in the band of 13.6 Mhz to have the refraction index of ‘0’. Further, the metamaterial structure 1000 has the negative effective permeability and the positive effective dielectric constant with respect the magnetic field in the frequency band of 13.4 to 13.6 Mhz to have the negative refraction index.

The metamaterial structure 1000 refracts the magnetic field which spreads radially from the transmitting antenna 2150 toward the receiving apparatus 2210. As a result, the metamaterial structure 1000 radiates a magnetic field MFair radiated to the atmosphere toward the receiving antenna 2210 when the metamaterial structure 1000 does not exist to transfer more magnetic fields from the transmitting antenna 2150 to the receiving antenna 2210. As a result, the power transmission efficiency may be improved while the wireless power transmission.

Hereinafter, a structure of the metamaterial structure 1000 according to the embodiment of the present invention will be described in detail.

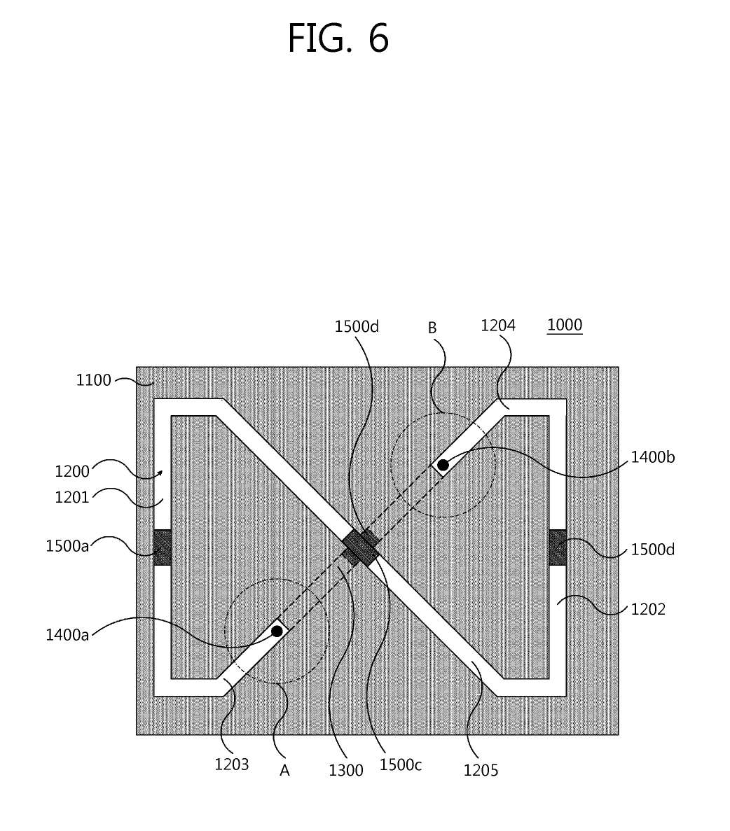

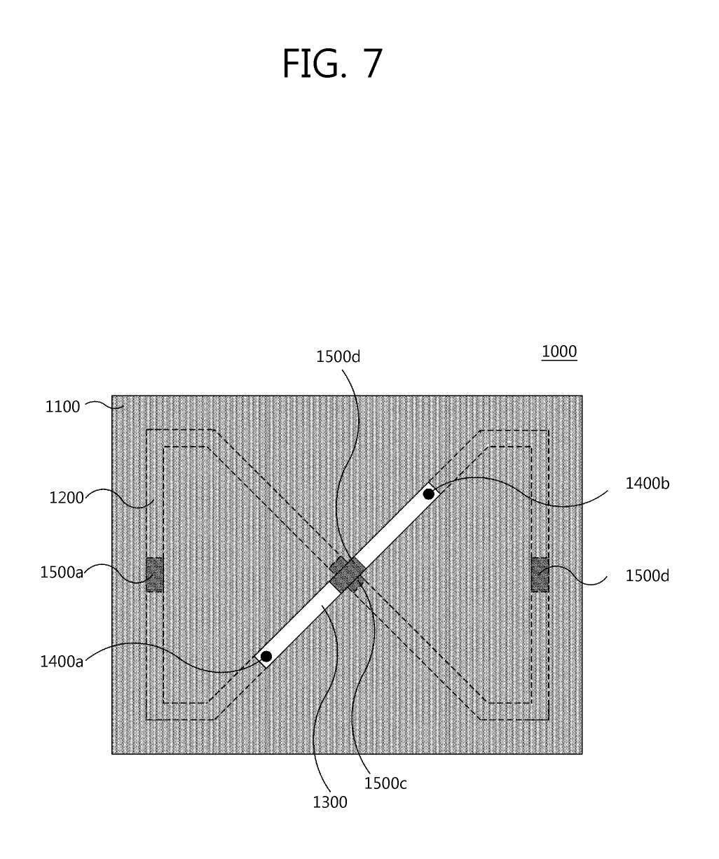

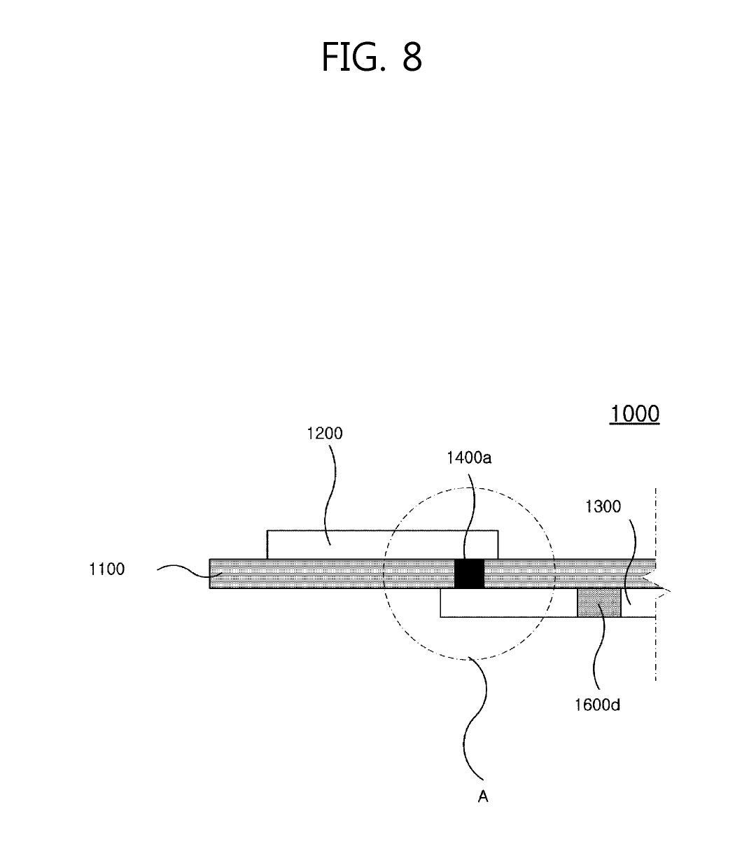

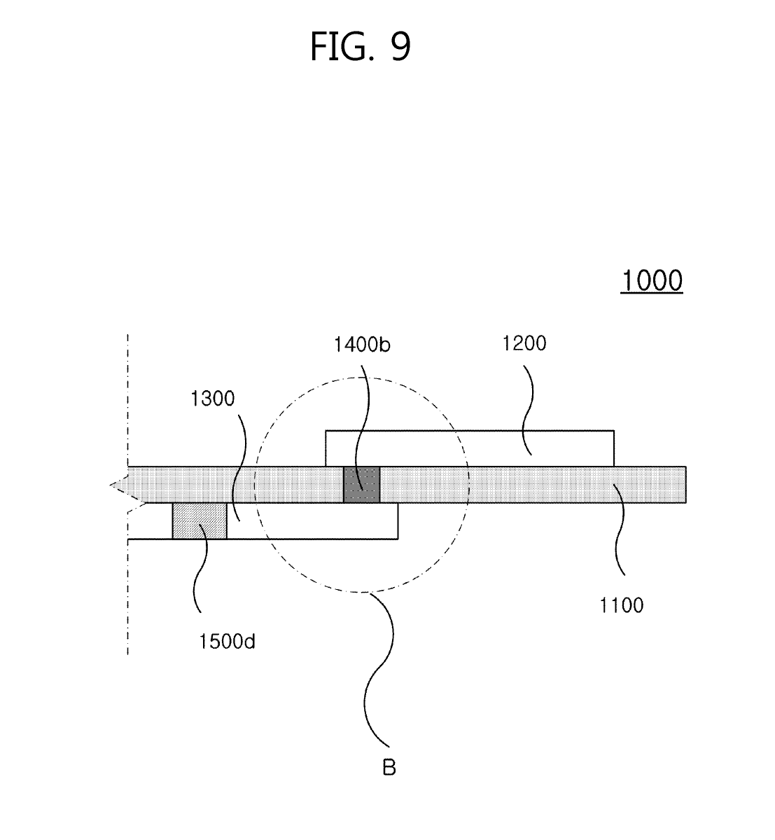

FIGS. 6 to 9 are diagrams regarding the metamaterial structure 1000 according to the embodiment of the present invention, and FIG. 6 is a plan view of a first form of the metamaterial structure 1000 according to the embodiment of the present invention, FIG. 7 is a bottom view of the first form of the metamaterial structure according to the embodiment of the present invention, FIG. 8 is a cross-sectional view of region A of FIG. 6, and FIG. 9 is a cross-sectional view of region B of FIG. 6.

Referring to FIGS. 6 to 9, the metamaterial structure 1000 may include a substrate 1100, a first conductor line 1200, a second conductor line 1300, a connection member 1400, and a capacitor 1500.

The substrate 1100 may be provided in a flat form. The substrate 1100 may be provided in such a manner that one surface of the substrate 1100 and the other surface which is an opposite surface thereto are parallel to each other. Further, the substrate 1100 may be made of a material that does not shield the magnetic field. For example, the substrate 1100 may be made of CER-10 or a material similar thereto.

Referring to FIG. 6 or 7, the first conductor line 1200 may be provided on one surface of the substrate 1100. For example, the first conductor line 1200 may be provided so as to be attached onto one surface of the substrate 1100. Alternatively, the first conductor line 1200 may be provided so as to be patterned with embossing or intaglio on one surface of the substrate 1100.

Referring to FIG. 6 or 7, the second conductor line 1300 may be provided on the other surface of the substrate 1100. The second conductor line 1300 may be provided on the substrate 1100 in the similar manner to the first conductor line 1200. For example, the second conductor line 1300 may be provided so as to be attached onto the other surface of the substrate 1100. Alternatively, the second conductor line 1300 may be provided so as to be patterned with embossing or intaglio on the other surface of the substrate 1100.

The first conductor line 1200 and the second conductor line 1300 may be deployed with both ends thereof positioned at the same locations from the top view. For example, the first conductor line 1200 and the second conductor line 1300 may be deployed with both ends thereof positioned at region A of FIG. 6 and region B of FIG. 6.

The connection member 1400 may connect the first conductor line 1200 and the second conductor line 1300. Referring to FIGS. 6 and 7, the connection member 1400 may be deployed at locations where both ends of the first conductor line 1200 and both ends of the second conductor line 1300 meet from the top view. For example, one connection member 1400 may be provided at each of regions A and B of FIG. 6. The connection member 1400 may extend from the first conductor line 1200 toward the second conductor line 1300 by passing through the substrate 1100 at the locations where both ends of the first conductor line 1200 and the second conductor line 1300 meet. For example, as illustrated in FIG. 9, the connection member 1400 may connect one end of the first conductor line 1200 and one end of the second conductor line 1300 through the substrate 1100 at region A. The connection member 1400 may connect the other end of the first conductor line 1200 and the other end of the second conductor line 1300 through the substrate 1100 at region B. As a result, the first conductor line 1200 and the second conductor line 1300 may be electrically connected with each other.

Herein, the first conductor line 1200 and the second conductor line 1300 may be deployed along a path forming a specific pattern from the top view. Referring to FIGS. 6 and 7, the first conductor line 1200 and the second conductor line 1300 may be provided to form a path having a twisted from the top view. For example, the first conductor line 1200 and the second conductor line 1300 may be provided to form a path having an ‘8’ shape, a twisted ribbon shape, or an unlimited symbol (‘∞’) shape from the top view.

Referring to FIGS. 6 and 7, the first conductor line 1200 may include both line portions 1201 and 1202 separated from and parallel to each other, a first diagonal line portion 1205 connected from any one upper end 1201 of both line portions 1201 and 1202 to the other one lower end 1202, a second diagonal line portion 1203 which extends from any one lower end 1201 of both line portion 1201 and 1202 up to region A toward the other one upper end 1202, and a third diagonal line portion 1204 which extends from the upper end of the other one both-side line portion 1202 up to region B toward the lower end of any one both-side line portion 1201.

Herein, the second diagonal line portion 1203 extends from region A to be connected to the lower end of any one both-side line portion 1201 and any one 1201 of the both-side line portion is connected to the first diagonal line portion 1205 at an upper end thereof again and the first diagonal line portion 1205 is connected to the lower end of the other one 1202 of the both-side line portion again and the other both-side line portion 1202 is connected to the third diagonal line portion 1204 at an upper end thereof, and the third diagonal line portion 1204 extends up to region A from the upper end of the other both-side line portion 1202. As a result, both line portions 1201 and 1202, the first diagonal line portion 1205, the second diagonal line portion 1203, and the third diagonal line portion 1204 may be provided to form one path from one end of region A up to the other end of region B.

Referring back to FIGS. 6 and 7, the second conductor line 1300 may extend from region A toward region B. Herein, one end of the second conductor line 1300 is connected with one end of the first conductor line 1200 by a connection member 1400a at region A as illustrated in FIG. 8. Further, the other end of the second conductor line 1300 is connected with the other end of the first conductor line 1200 by a connection member 1400b at region B as illustrated in FIG. 9.

As a result, the first conductor line 1200 and the second conductor line 1300 may be generally connected to each other and provided to form the path having the ‘8’ shape, the twisted ribbon shape, or the unlimited symbol (‘∞’) shape from the top view.

However, herein, the shapes of the first conductor line 1200 and the second conductor line 1300 are not particularly limited to the aforementioned example.

For example, the first conductor line 1200 may be constituted only by both line portions 1201 and 1202 parallel to each other and the first diagonal line portion 1205 and the second conductor line 1300 may extend from the lower end of any one 1201 of both line portions up to the upper end of the other one 1202. Of course, in this case, the connection member 1400 may connect the first conductor line 1200 and the second conductor line 1300 at the lower end of any one 1201 of both line portions and connect the first conductor line 1200 and the second conductor line 1300 at the upper end of the other one 1202 of both line portions. Even in this case, the first conductor line 1200 and the second conductor line 1300 may be generally connected to each other and provided to form the path having the ‘8’ shape, the twisted ribbon shape, or the unlimited symbol (‘∞’) shape from the top view.

As the other example, the first conductor line 1200 may be constituted only by any one 1201 of both line portions and the first diagonal line portion 1205 and the second conductor line 1300 may include a line deployed at the position of the other one 1202 of both line portions from the top view and a diagonal line portion deployed at a position connected from the other end of any one 1201 to the upper end of the other one 1202 from the top view. Even in this case, the first conductor line 1200 and the second conductor line 1300 may be generally connected to each other and provided to form the path having the ‘8’ shape, the twisted ribbon shape, or the unlimited symbol (‘∞’) shape from the top view.

In other words, the first conductor line 1200 and the second conductor line 1300 are deployed on opposite surfaces of the substrate 1100 to each other, both ends are connected by the connection member 1400 at the same location and deployed to form the path having the ‘8’ shape, the twisted ribbon shape, or the unlimited symbol (‘∞’) shape from the top view and herein, a location connecting the first conductor line 1200 and the second conductor line 1300 may be arbitrarily selected from any two locations on the path.

The capacitor 1500 may be provided to be inserted into any one of the first conductor line 1200 and the second conductor line 1300 on the path formed by the first conductor line 1200 and the second conductor line 1300. One or multiple capacitors 1500 may be provided.

For example, referring to FIGS. 6 and 7, the capacitor 1500 may include capacitors 1500a and 1500b inserted into each of both line portions 1201 and 1202 of the first conductor line 1200, respectively, a capacitor 1500c inserted into the first diagonal line portion 1205 of the first conductor line 1200, and a capacitor 1500d inserted into the second conductor line 1300.

The metamaterial structure 1000 having the aforementioned structure may have the refraction index of ‘0’ or the negative refraction index with respect to the electromagnetic field.

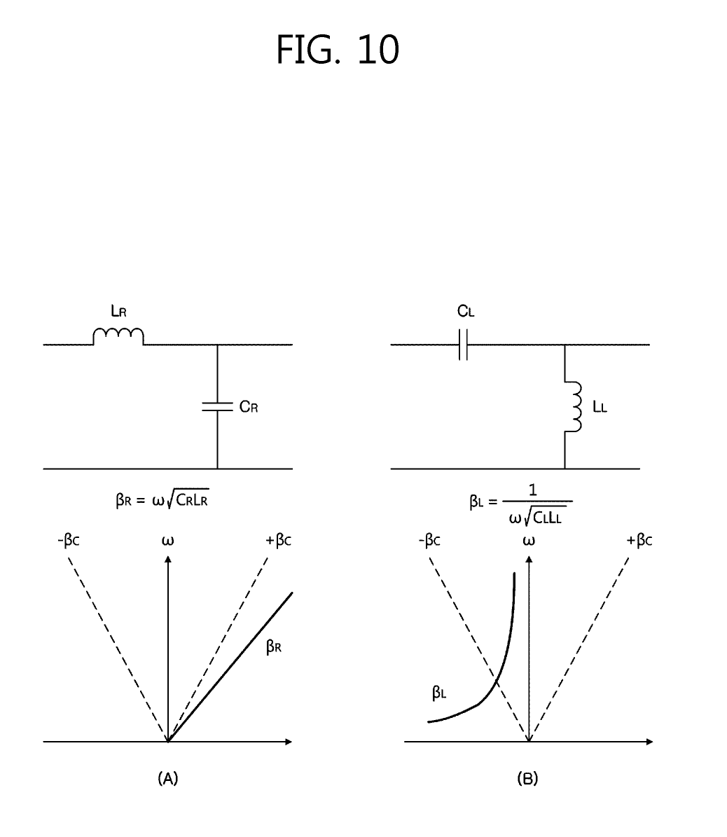

FIG. 10 is a graph regarding a refractive index of the first form of the metamaterial structure according to the embodiment of the present invention.

Referring to FIG. 10, an equivalent circuit of the metamaterial structure 1000 needs to be provided to have a value of ‘0’ or a negative 0 value in order to have the refraction index of ‘0’ or the negative refraction index with respect to the magnetic field.

To this end, the metamaterial structure 1000 needs to be provided in a purely left-handed (PLH) structure. That is, the equivalent circuit of the metamaterial structure 1000 needs to be configured to have serial capacitance and parallel capacitance.

In the metamaterial structure 1000 having the structure described in FIGS. 6 to 9, the serial capacitance may be generated by the capacitor 1500 inserted into the first conductor line 1200 or the second conductor line 1300. Further, the parallel inductance may be generated at a portion where the first conductor line 1200 and the second conductor line 1300 are connected by the connection member 1400. As a result, the metamaterial structure 1000 provided in the structure of FIGS. 6 to 9 forms the PLH structure to have the refraction index of ‘0’ or the negative refraction index with respect to the electromagnetic field.

Meanwhile, herein, the first conductor line 1200 and the second conductor line 1300 may be provided in such a manner that the paths formed by the first conductor line 1200 and the second conductor line 1300 are generally symmetric to each other from the top view. Further, when a plurality of capacitors 1500 is provided, the capacitors 1500 may be deployed at positions symmetric to each other based on a center of the paths formed by the first conductor line 1200 and the second conductor line 1300. For example, the capacitors 1500 may be deployed at portions where the first conductor line 1200 and the second conductor line 1300 overlap with each other or provided at positions line-symmetric or point-symmetric based on the overlapped portion as a pair from the top view.

Like this, when the paths formed by the first conductor line 1200 and the second conductor line 1300 have a symmetric structure, the resulting generated inductance forms a balance and further, when the capacitors 1500 are symmetrically deployed, the resulting generated capacitance forms the balance, and as a result, the electromagnetic field is stably refracted in overall, thereby more stably focusing the electromagnetic field.

Hereinafter, various modified examples having a form provided by the metamaterial structure 1000 according to the embodiment of the present invention will be described.

In the first form of the metamaterial structure 1000 of FIGS. 6 to 9, it is described that each of the capacitors 1500a, 1500b, 1500c, and 1500d is deployed at both line portions 1201 and 1202 of the first conductor line 1200, and the first diagonal line portion 1205 and the second conductor line 1300. Herein, the capacitor 1500 needs not particularly be deployed at the aforementioned position.

For example, the number of capacitors 1500 may be appropriately added and subtracted.

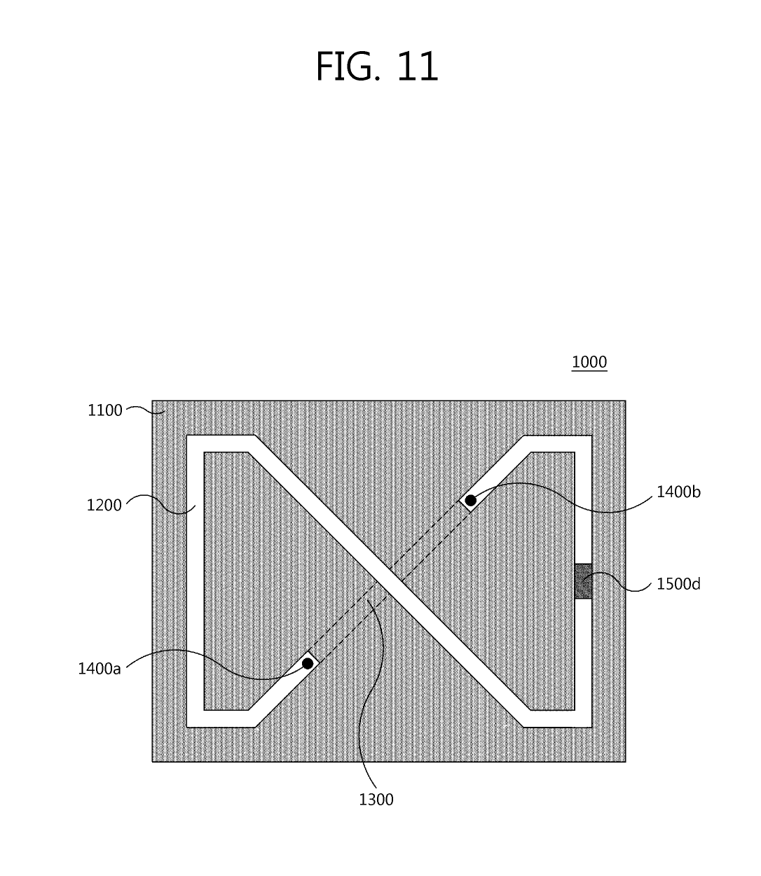

FIG. 11 is a diagram regarding the second form of the metamaterial structure according to the embodiment of the present invention. Referring to FIG. 11, the capacitor 1500 may include only one capacitor 1500b deployed in the other one 1202 between both members of the first conductor line 1200.

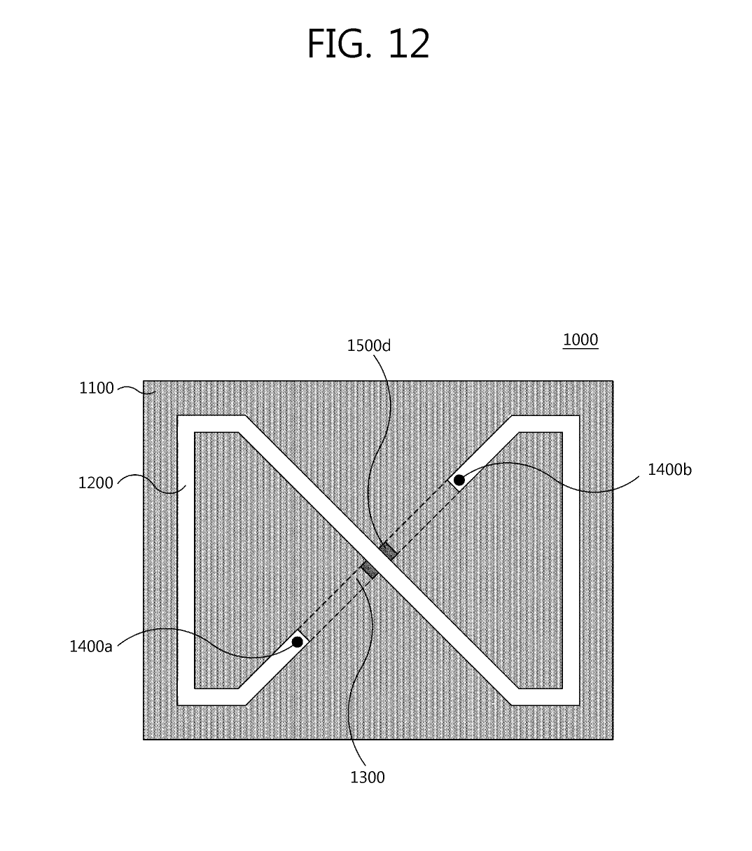

FIG. 12 is a diagram regarding a third form of the metamaterial structure 1000 according to the embodiment of the present invention. Referring to FIG. 12, the capacitor 1500 may include only one capacitor 1500d deployed in the second conductor line 1300.

Besides, the capacitors may be appropriately deployed at desired locations with the desired number. For example, the metamaterial structure 1000 may include at least one of the first capacitor 1500a, the second capacitor 1500b, the third capacitor 1500c, and the fourth capacitor 1500d.

Further, the position of the capacitor 1500 is not limited to the positions of the first capacitor 1500a, the second capacitor 1500b, the third capacitor 1500c, and the fourth capacitor 1500d and may be deployed at different positions with the desired number.

Meanwhile, an air capacitor may be used instead of the capacitor 1500. In other words, a gap may be formed at a position provided by the capacitor 1500. The gap may serve as the air capacitor.

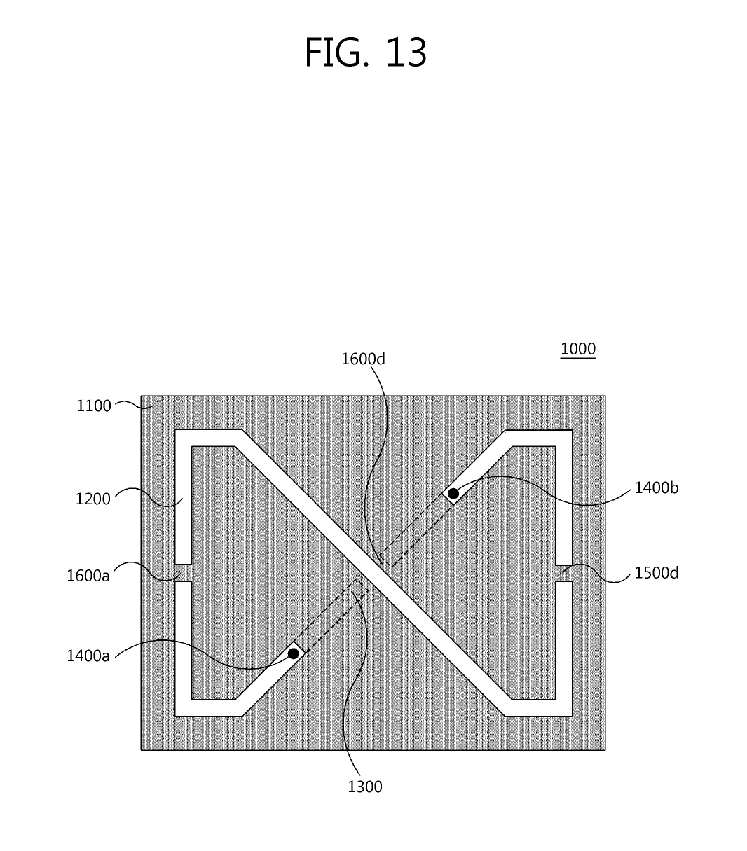

FIG. 13 is a diagram regarding a fourth form of the metamaterial structure 1000 according to the embodiment of the present invention.

A first gap 1600a, a second gap 1600d, and a third gap 1600d may be formed in the first conductor line 1200 and the second conductor line 1300 instead of the positions at which the first capacitor 1500a, the second capacitor 1500b, and the fourth capacitor 1500d are deployed. Herein, the third capacitor 1500c may be omitted.

Of course, when the capacitor 1500 is substituted with the air capacitor as described above, all capacitors 1500 need not particularly be substituted with the air capacitors and all or some of the capacitors 1500 may be substituted with the air capacitors.

Herein, the gap 1600 serving as the air capacitor is not limited to the aforementioned example and may be appropriately deployed at desired positions with the desired number.

Further, in the metamaterial structure 1000, the gap 1600 which is the air capacitor and the capacitor 1500 may be simultaneously provided.

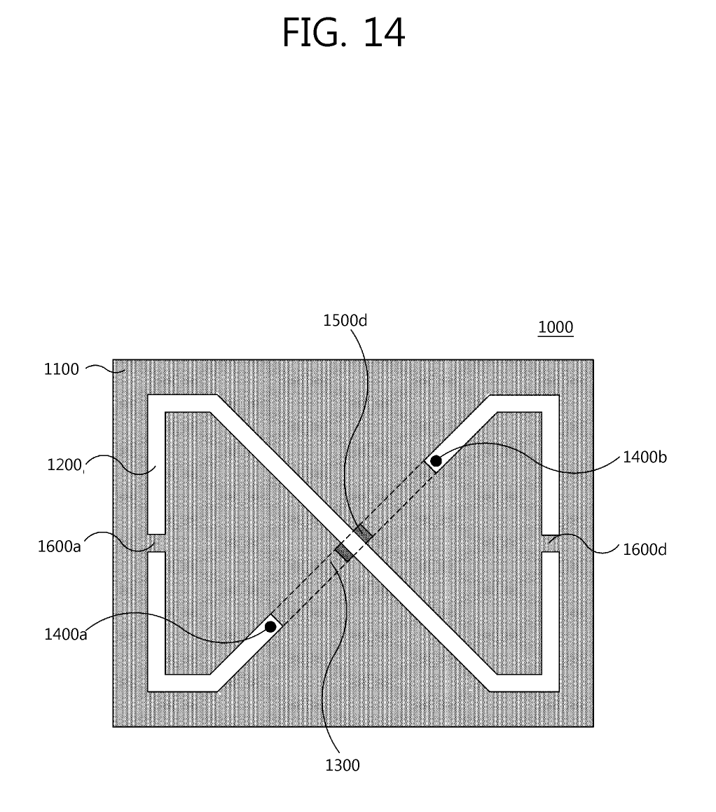

FIG. 14 is a diagram regarding a fifth form of the metamaterial structure according to the embodiment of the present invention.

Referring to FIG. 14, two gaps 1600a and 1600b and one capacitor 1500d are provided in the metamaterial structure 1000.

In other words, the capacitor 1500 and the gap 1600 may be appropriately combined and deployed at desired positions and at desired locations in the first conductor line 1200 and the second conductor line 1300.

When various forms of metamaterial structures 1000 of FIGS. 6 to 9 and FIGS. 11 to 14 are summarized, the metamaterial structure 1000 includes the first conductor line 1200 and the second conductor line 1300 connected by the connection member 1400, provided on opposite surfaces of the substrate 1100 to each other, and forming a twisted path from the top view, and the capacitors 1500 and the gaps 1600 may be provided at desired positions and desired locations on the first conductor line 1200 and the second conductor line 1300 at the appropriate number. Herein, the capacitor 1500 and the gap 1600 may be generally deployed at the positions symmetric to each other from the top view and a pattern having the twisted form, which is formed by the first conductor line 1200 and the second conductor line 1300 may also have a symmetric structure from the top view.

Hereinafter, another modified example of the metamaterial structure 1000 will be described.

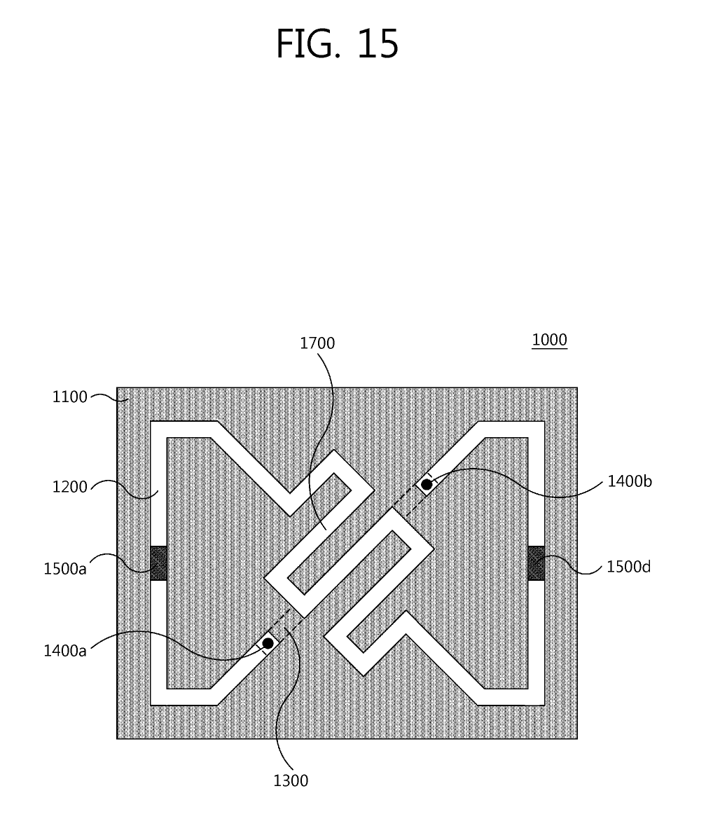

FIGS. 15 to 17 are diagrams regarding a modified example in which a zigzag pattern is added to the metamaterial structure 1000 according to the embodiment of the present invention.

FIG. 15 is a diagram regarding a sixth form of the metamaterial structure according to the embodiment of the present invention.

Referring to FIG. 15, the first conductor line 1200 may include a zigzag pattern portion 1700. The zigzag pattern portion 1700 may be formed in the first diagonal line portion 1205 of FIG. 6. That is, the first diagonal line portion 1205 may have a pattern formed in zigzags at the center thereof. The zigzag pattern portion 1700 generates capacitance by coupling between the paths forming the pattern to show a similar effect to a case in which the capacitor 1500 is inserted into the first conductor line 1200.

Meanwhile, even when the first conductor line 1200 has the zigzag pattern portion 1700, the capacitor 1500 and the gap 1600 may be appropriately changed to the desired number at the desired position.

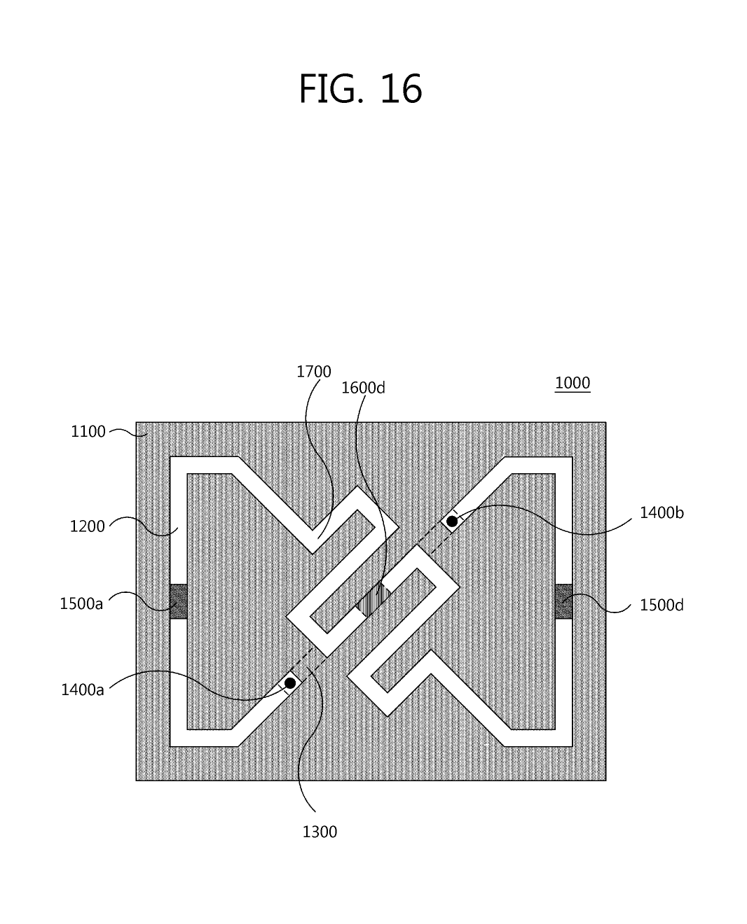

FIG. 16 is a diagram regarding a seventh form of the metamaterial structure 1000 according to the embodiment of the present invention.

Referring to FIG. 16, it may be illustrated that the capacitor 1500d is added to the second conductor line 1300 as compared with FIG. 15. Besides, some of the respective capacitors 1500a, 1500b, and 1500d may be omitted or the respective capacitors 1500a, 1500b, and 1500d may be modified to the gap 1600 which is the air capacitor and the capacitor 1500 may be inserted into the zigzag pattern portion 1700.

Meanwhile, in FIGS. 15 and 16, it is described that the zigzag pattern portion 1700 is formed in the first conductor line 1200 of FIG. 6, but the zigzag pattern portion 1700 may be formed in the second conductor line 1300.

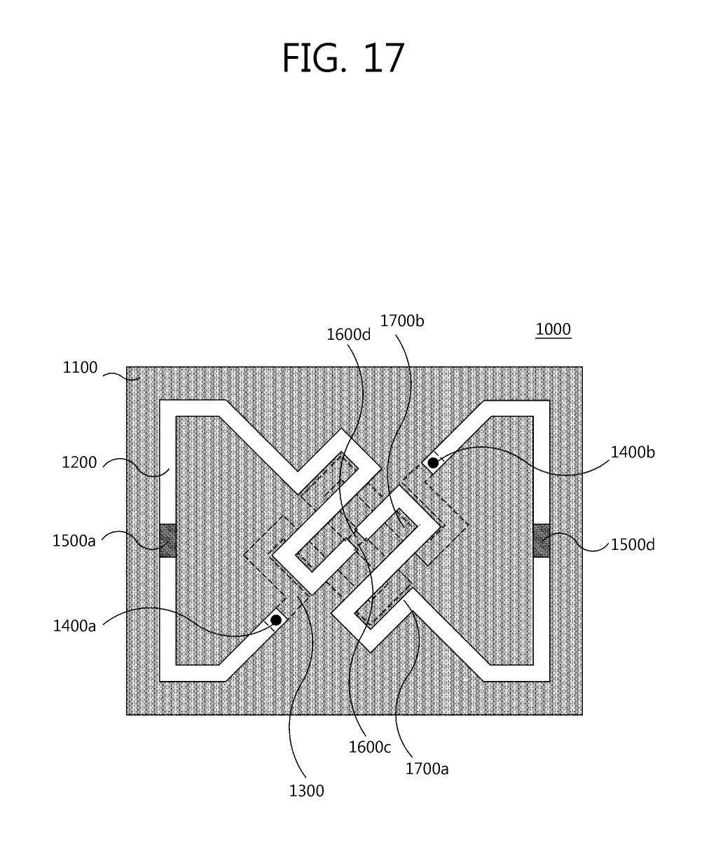

FIG. 17 is a diagram regarding an eighth form of the metamaterial structure 1000 according to the embodiment of the present invention.

Referring to FIG. 17, a first zigzag pattern portion 1700a may be provided to the first conductor line 1200 and a second zigzag pattern portion 1700b may be provided to the second conductor line 1300.

Hereinabove, various forms of metamaterial structures 1000 have been described with reference to FIGS. 6 to 9 and FIGS. 10 to 17. However, the shape of the metamaterial structure 1000 according to the embodiment of the present invention is not limited to the aforementioned form.

For example, in the metamaterial structure 1000, the capacitor 1500, the gap 1600 which is the air capacitor, and the zigzag pattern portion 1700 may be deployed at appropriate positions with the appropriate number as necessary.

Further, the respective forms of the metamaterial structures 1000 may be combined with each other.

The above description is illustrative purpose only and various modifications and transformations become apparent to those skilled in the art within a scope of an essential characteristic of the present invention.

Accordingly, the various embodiments disclosed herein are not intended to limit the technical spirit but describe with the scope of the technical spirit of the present invention. The scope of the present invention should be interpreted by the appended claims and all technical spirit in the equivalent range is intended to be embraced by the appended claims of the present invention.

### DESCRIPTION OF MARK

1000: metamaterial structure
1100: substrate
1200: first conductor line
1300: second conductor line
1400: connection member
1500: power receiving module
1600: gap
1700: zigzag pattern portion
2000: wireless power transmitting system
2100: wireless power transmitting apparatus
2110: AC-DC converter
2120: frequency oscillator
2130: power amplifier
2140: impedance matcher
2150: transmitting antenna
2200: wireless power receiving apparatus
2210: receiving antenna
2220: impedance matcher
2230: rectifier
2240: DC-DC converter
2250: battery
S: power source

What is claimed is:

1. A metamaterial structure refracting a magnetic field having a specific frequency, the metamaterial structure comprising:
a substrate;
a first conductor line deployed on one surface of the substrate;
a second conductor line deployed on the other surface of the substrate; and
two connection members connecting both ends of the first conductor line and the second conductor line through the substrate,
wherein the first conductor line and the second conductor line have both ends positioned at the same location from the top view and are provided to form twisted paths.

2. The metamaterial structure claim 1, wherein the first conductor line and the second conductor line are provided to form having an ‘8’ shape, a twisted ribbon shape, or an unlimited symbol shape from the top view.

3. The metamaterial structure claim 1, wherein the first conductor line and the second conductor line are provided in such a manner that a path formed by the first conductor line and a path formed by the second conductor line cross each other from the top view.

4. The metamaterial structure claim 3, wherein the first conductor line and the second conductor line are provided to form paths symmetric to each other at a location where the path formed by the first conductor line and the path formed by the second conductor line cross each other from the top view.

5. The metamaterial structure claim 1, wherein at least one gap serving as an air capacitor is formed on the paths formed by the first conductor line and the second conductor line.

6. The metamaterial structure claim 5, wherein:
the first conductor line and the second conductor line are provided in such a manner that the path formed by the first conductor line and the path formed by the second conductor line cross each other from the top view,
the first conductor line and the second conductor line are provided to form paths symmetric to each other at a location where the path formed by the first conductor line and the path formed by the second conductor line cross each other from the top view, and
the at least one gap is provided at a position symmetric to each other at the location where the first conductor line and the second conductor line cross each other or provided at a position where the first conductor line and the second conductor line cross each other.

7. The metamaterial structure claim 1, further comprising:
at least one capacitor inserted on the paths formed by the first conductor line and the second conductor line.

8. The metamaterial structure claim 7, wherein:
the first conductor line and the second conductor line are provided in such a manner that the path formed by the first conductor line and the path formed by the second conductor line cross each other from the top view,
the first conductor line and the second conductor line are provided to form paths symmetric to each other at a location where the path formed by the first conductor line and the path formed by the second conductor line cross each other from the top view, and
the at least one capacitor is provided at a position symmetric to each other at the location where the first conductor line and the second conductor line cross each other or provided at a position where the first conductor line and the second conductor line cross each other.

9. The metamaterial structure claim 1, wherein at least one of the first conductor line and the second conductor line includes a pattern line provided onto the formed by the first conductor line and the second conductor line in zigzags.

10. The metamaterial structure claim 9, wherein:
the first conductor line and the second conductor line are provided in such a manner that the path formed by the first conductor line and the path formed by the second conductor line cross each other from the top view,
the first conductor line and the second conductor line are provided to form paths symmetric to each other at a location where the path formed by the first conductor line and the path formed by the second conductor line cross each other from the top view, and
the at least one patter line is provided at a position symmetric to each other at the location where the first conductor line and the second conductor line cross each other or provided at a position where the first conductor line and the second conductor line cross each other.
